(19) United States
(12) Patent Application Publication
(10) Pub. No.: US 2009/0202318 A1
(43) Pub. Date: Aug. 13, 2009

(54) LOCK DEVICE

(75) Inventors: Ting-Jui Wang, Sindian City (TW); Ming-De WU, Sindian City (TW)

Correspondence Address: SCHMEISER, OLSEN & WATTS, 22 CENTURY HILL DRIVE, SUITE 302, LATHAM, NY, 12110, US

(73) Assignee: FIVETECH TECHNOLOGY INC., Sindian City (TW)

(21) Appl. No.: 12/030,313

(22) Filed: Feb. 13, 2008

(51) Int. Cl. F16B 39/02

(52) U.S. Cl. 411/295

(57) ABSTRACT

An improved lock device includes: a locking unit, having a force exerted portion, a screw rod section and a screw thread section sequentially disposed on a surface of the force exerted portion, and an embedded groove disposed around the periphery of the screw rod section; and a ferrule, having an embedding edge and a latch groove, and the embedding edge installed into the embedded groove for movably coupling the ferrule to the locking unit, such that the invention can use the ferrule latch groove and the locking unit for locking a board with a base as required.

### FIELD OF THE INVENTION

The present invention relates to an improved lock device, and more particularly to a lock device that makes use of the capability of removing from a screw connection between a board and a screw to provide a better reliability of its application through a resilient element, when the board is secured or removed.

### BACKGROUND OF THE INVENTION

In FIGS. 1 to 3, a traditional locking unit 6 includes a force exerted portion 61 disposed at an end of the locking unit 6, and a screw rod 62 disposed at another end and connected to the force exerted portion 61, and the screw rod 62 is aligned with a through hole 71 of a board 7, and a tool is used for applying an external rotating force to the force exerted portion 61, such that the force exerted portion 61 compresses the board 7, and the screw rod 62 is locked into a through hole 81 of a base 8 through the board 7 to complete locking the board 7 with the base 8. If it is necessary to remove the locking unit 6, an external rotating force is applied in an opposite direction to the force exerted portion 61, so that the screw rod 62 is separated from the through holes 81, 71 of the base 8 and the board 7 to complete removing the locking unit 6.

Although the aforementioned traditional locking unit 6 can lock the board 7 with the base 8, the locking unit 6 is connected to the board 7 and the base 8, and thus the force exerted portion 61 compresses the board 7. If it is necessary to remove the locking unit 6 from the board 7 and the base 8 in order to separate the board 7 from the base 8 after the force exerted portion 61 is locked with the board 7, then it is necessary to use the locking unit 6 to separate the board 7 from the base 8 after the screw rod 62 is separated from the board 7 and the base 8. Since the locking unit 6 and the board 7 do not come with a connecting characteristic, therefore the screw rod 62 cannot be unscrewed from the board 7 and the base 8 for driving the board 7 to be separated from the base 8.

### SUMMARY OF THE INVENTION

In view of the foregoing shortcomings of the prior art, the inventor of the present invention based on years of experience in the related field to conduct extensive researches and experiments, and finally developed an improved lock device in accordance with the present invention to overcome the shortcomings of the prior art.

Therefore, it is a primary objective of the present invention to use the latch groove of the ferrule and the locking unit for locking the board with the base, and also use the capability of removing from a connection between the board and the screw to lock or remove the board, so as to achieve a quick and power saving effect of separating a board from another board.

To achieve the foregoing objective, the present invention provides an improved lock device, comprising: a locking unit, having a force exerted portion; a screw rod section and a screw thread section sequentially disposed on a surface of the force exerted portion; and an embedded groove disposed around the periphery of the screw rod section; and a ferrule, having an embedding edge installed into the embedded groove for movably coupling the ferrule with the locking unit.

### BRIEF DESCRIPTION OF THE DRAWINGS

FIG. 1 is a perspective view of a prior art;

FIG. 2 is a schematic view of a locked status of a prior art;

FIG. 3 is a schematic view of a removed status of a prior art;

FIG. 4 is an exploded view of a removed status of the present invention;

FIG. 5 is a perspective view of the present invention;

FIG. 6 is a cross-sectional view of the present invention;

FIG. 7 is a schematic view of a locked status of the present invention;

FIG. 8 is a schematic view of a removed status of the present invention;

FIG. 9 is another exploded view of the present invention;

FIG. 10 is another perspective view of the present invention;

FIG. 11 is another cross-sectional view of the present invention;

FIG. 12 is another schematic view of an installed status of the present invention;

FIG. 13 is another schematic view of a locked status of the present invention; and

FIG. 14 is another schematic view of a removed status of the present invention.

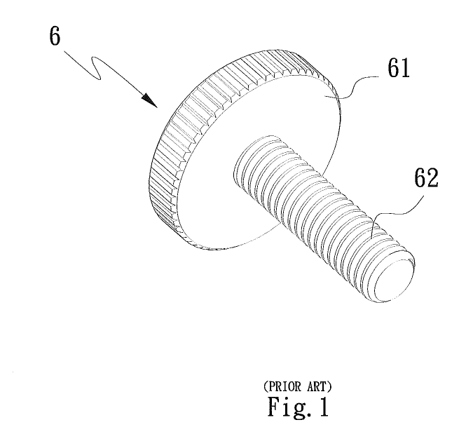

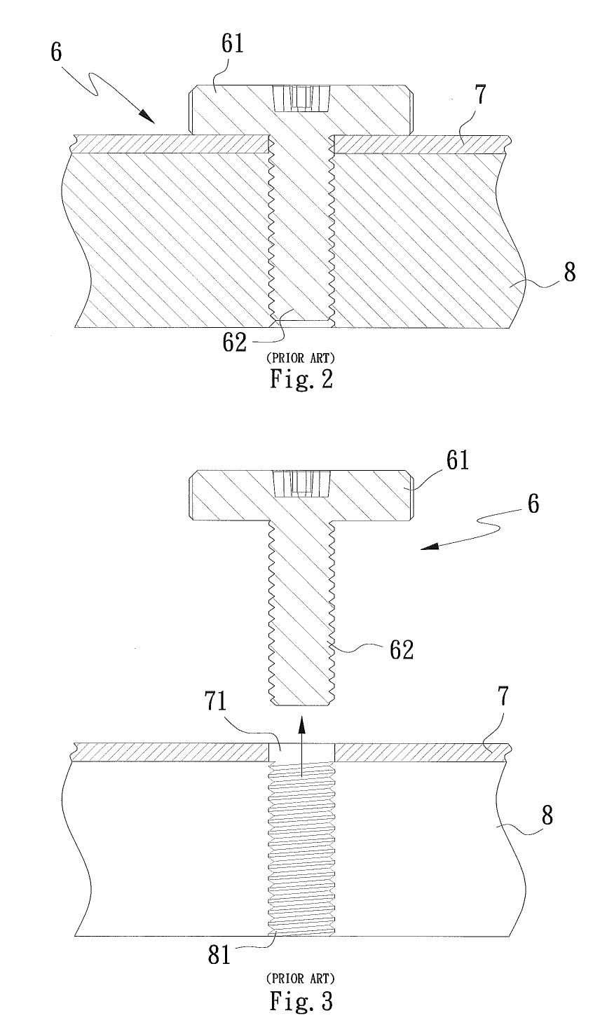

### DESCRIPTION OF THE PREFERRED EMBODIMENT

The above and other objects, features and advantages of the present invention will become apparent from the following detailed description taken with the accompanying drawing.

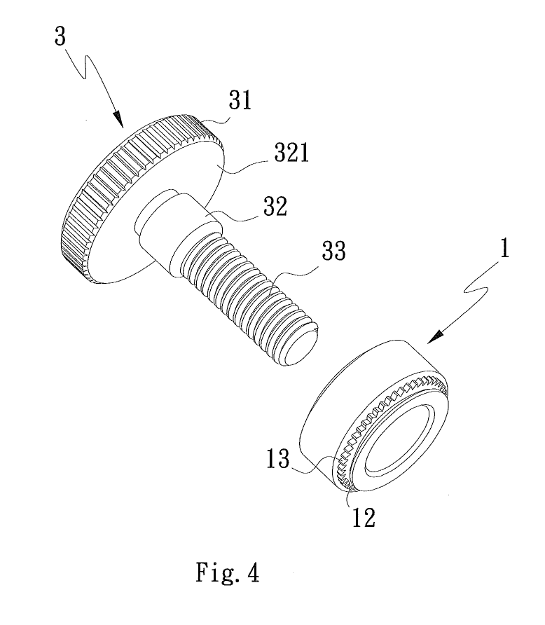

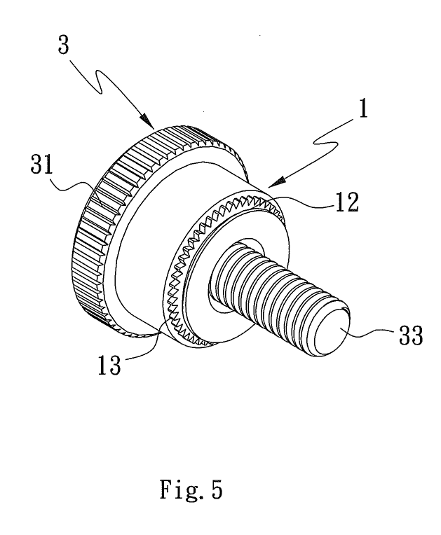

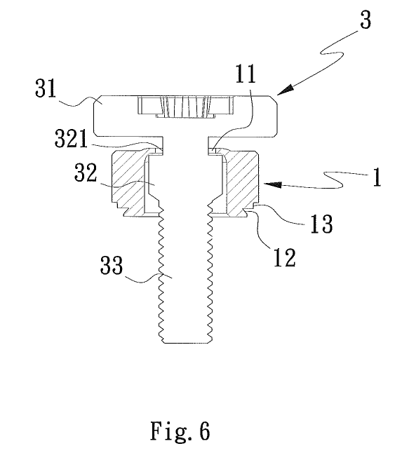

Referring to FIGS. 4 to 6 for an exploded view, a schematic view, and a cross-sectional view of the present invention respectively, the invention provides an improved lock device comprising a ferrule 1 and a locking unit 3.

The locking unit 3 comprises: a force exerted portion 31; a screw rod section 32 and a screw thread section 33 sequentially disposed on a surface of the force exerted portion 31; and an embedded groove 321 disposed around the periphery of the screw rod section 32.

The ferrule 1 comprises an embedding edge 11 disposed at an end of the ferrule 1, a latch groove 12 disposed at another end of the ferrule 1, and a serrated portion 13 disposed between the latch groove 12 and another end of the ferrule 1, and the embedding edge 11 is installed into the embedded groove 321 such that the ferrule 1 can be movably installed at the locking unit 3. The aforementioned structure constitutes a novel improved lock device.

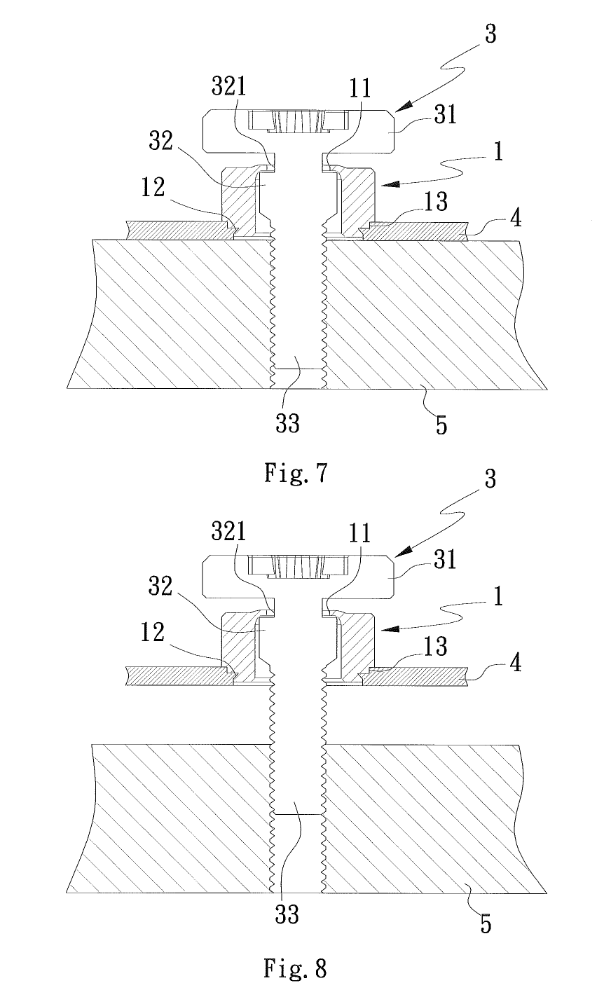

Referring to FIGS. 7 and 8 for schematic views of a locked status and a removed status of the present invention respectively, a latch groove 12 of the ferrule 1 is embedded into a board 4 for locking the board 4 with a base 5, and the serrated portion 13 constitutes an interference with the board 4, and the force exerted portion 31 is rotated by applying an external rotating force at the locking unit 3 by a tool, such that the screw thread section 33 is locked onto the base 5 to complete locking the board 4 with the base 5.

If it is necessary to remove locking unit 3 from the board 4, a tool is used for applying an external rotating force in an opposite direction to the force exerted portion 31 of the locking unit 3 to separate the screw thread section 33 from the base 5, and pull the ferrule 1 to remove the board 4. Since the latch groove 12 of the ferrule 1 is embedded into the board 4, therefore when the ferrule 1 is pulled, the latch groove 12 is used for driving the board 4 to achieve the effect of separating the board 4 from the base 5.

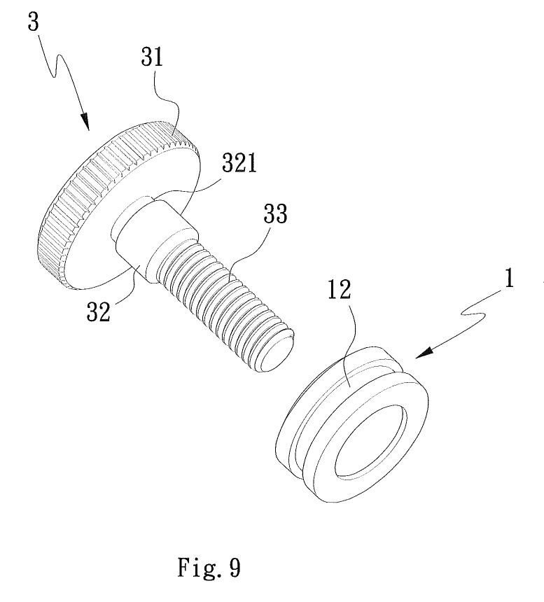

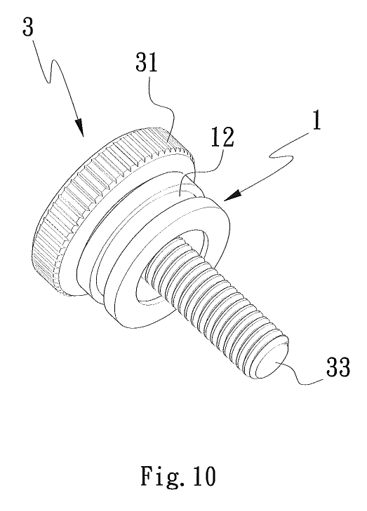

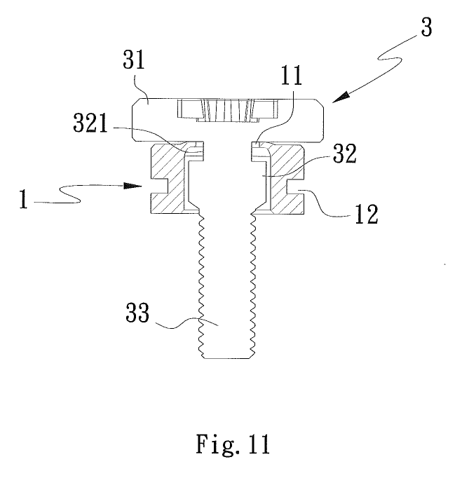

Referring to FIGS. 9 to 11 for another exploded view, another perspective view and another cross-sectional view of the present invention respectively, the invention provides an improved lock device comprising a ferrule 1 and a locking unit 3.

The locking unit 3 comprises a force exerted portion 31, a screw rod section 32 and a screw thread section 33 disposed on a surface of the force exerted portion 31, and an embedded groove 321 disposed around the periphery of the screw rod section 32.

The ferrule 1 comprises an embedding edge 11 disposed at an end of the ferrule 1, a latch groove 12 disposed at the periphery of the ferrule 1, and an embedded groove 321 disposed at an embedding edge 11 such that the ferrule 1 can be movably installed at the locking unit 3. The aforementioned structure constitutes another novel improved lock device.

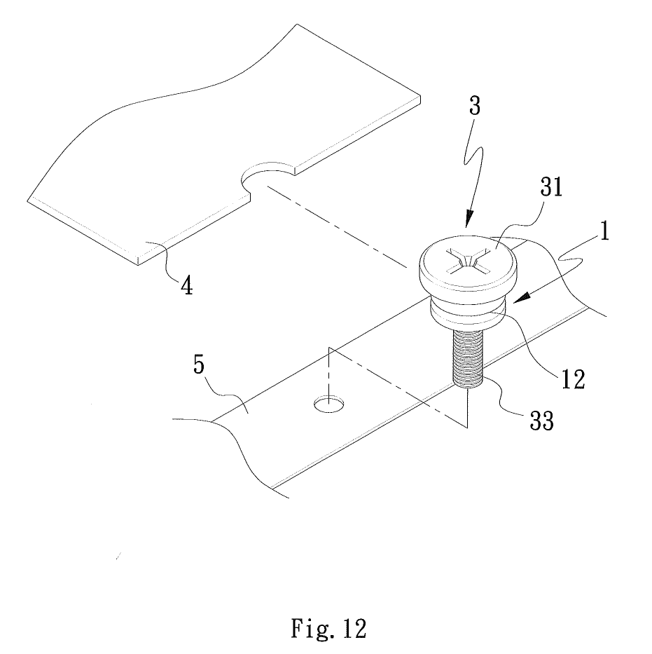

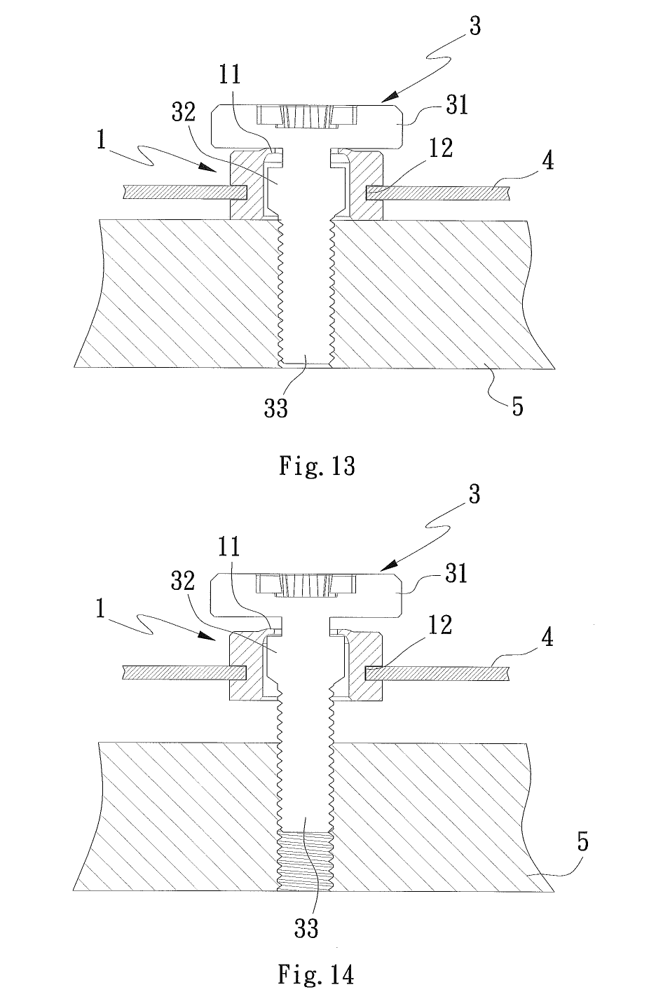

Referring to FIGS. 12 to 14 for other schematic views of an installed status, a locked status and a removed status of the present invention respectively, the board 4 is locked with a base 5 by embedding the latch groove 12 of the ferrule 1 with the periphery of the board 4, and a tool is used for applying an external rotating force to rotate the force exerted portion 31 on the locking unit 3, such that the screw thread section 33 is locked onto the base 5 to complete locking the board 4 with the base 5.

If it is necessary to remove the locking unit 3 in order to separate the board 4, the tool is used for applying an external rotating force in an opposite direction to the force exerted portion 31 of the locking unit 3, such that the screw thread section 33 is separated from the base 5, and the ferrule 1 is pulled to remove the board 4. Since the periphery of the board 4 is embedded into the latch groove 12 of the ferrule 1, therefore the ferrule 1 is pulled to achieve the effect of using the latch groove 12 to drive the board 4 to separate from the base 5.

In summation of the description above, the improved lock device of the invention can effectively overcome the shortcomings of the prior art, and apply the latch groove of the ferrule and the locking unit to lock the board with the base. Such arrangement can prevent the resilient element from being damaged by external forces or titled by external objects, so that the resilient element can achieve a better stability of the application. The invention complies with the requirements of patent application, and thus is duly filed for patent application.

While the invention has been described by means of specific embodiments, numerous modifications and variations could be made thereto by those skilled in the art without departing from the scope and spirit of the invention set forth in the claims.

What is claimed is:

1. An improved lock device, comprising:
a locking unit, having a force exerted portion, a screw rod section and a screw thread section sequentially disposed on a surface of the force exerted portion, and an embedded groove disposed around the periphery of the screw rod section; and
a ferrule, having an embedding edge, installed into the embedded groove for movably coupling the ferrule to the locking unit.

2. The improved lock device of claim 1, wherein the embedding edge is installed at an end of the ferrule.

3. The improved lock device of claim 1, wherein the ferrule has a latch groove.

4. The improved lock device of claim 3, wherein the latch groove is disposed at another end of the ferrule.

5. The improved lock device of claim 4, wherein the latch groove and another end of the ferrule further includes a serrated portion.

6. The improved lock device of claim 3, wherein the latch groove is disposed at the periphery of the ferrule.
